(19) United States
(12) Patent Application Publication
(10) Pub. No.: US 2009/0027669 A1
(43) Pub. Date: Jan. 29, 2009

(54) PORTABLE DEVICE FOR THE QUALITY CONTROL OF PRODUCTS

(76) Inventors: Bruno Zauli, Imola Bologna (IT); Marco Remondini, Imola Bologna (IT); Gildo Bosi, Imola Bologna (IT)

Correspondence Address: BROWDY AND NEIMARK, P.L.L.C.;624 NINTH STREET, NW, SUITE 300, WASHINGTON, DC, 20001-5303, US

(21) Appl. No.: 12/162,463

(22) PCT Filed: Mar. 24, 2006
(86) PCT No.: PCT/IT2006/000190

§ 371 Date: Sep. 15, 2008

(30) Foreign Application Priority Data
Feb. 1, 2006 (IT) RE2006A000010

(51) Int. Cl. G01N 21/25

(52) U.S. Cl. 356/326

(57) ABSTRACT

A portable device for the quality control of vegetal products comprising a power supply (7) intended for powering a circular crown of lighting lamps (41) at the centre of which there is arranged the receiving objective of a spectrometer (45) provided with means (431) adapted for resting on the product to be checked, said spectrometer (45) being associated to a microprocessor (11) which provides the measurement data on display means (12); according to the invention, the lamps (41) are permanently powered, and in stand-by, at a reduced voltage (70), lower than the nominal voltage (71) delivered by the power supply (7), and instantaneously at the nominal voltage (71 supplied by the power supply (7) through a power circuit (8) whose activation is commanded and controlled by the microprocessor (11) in response to an activation signal generated by a button (10).

### TECHNICAL FIELD

The present patent relates to the technical field of the quality control of vegetal products in particular, such as fruit and vegetables, and of other products with similar features.

In particular, the present invention relates to the quality control by spectroscopic analysis of the product.

### BACKGROUND ART

Devices have been setup, which substantially comprise a chain conveyer whose links consist of bowls, each adapted for receiving a fruit, associated to spectroscopic analysis means.

According to the prior art, the spectroscopic analysis means comprises means for lighting the fruit and means for gathering the light refracted by the fruit and for the spectroscopic analysis of the same.

The chain moves with a continuous motion in front of said lighting means and the light gathering and spectroscopic analysis means is arranged so that upon the passage of the fruit, at least a portion of the light crossing the fruit is gathered and sent to a spectrometer.

The data gathered by the spectrometer are analysed by a processor and are converted into parameters telling the ripening level and in general, the product quality.

An equipment of the above type is described, for example, in document EP 1215480 A1.

The fixed installations of the type mentioned above, besides a high cost and the poor versatility, exhibit some disadvantages that restrict the use thereof.

They comprise lighting devices of sensible power, in the range of 2000 W, which are necessary for making the measurement as little as possible influenced by the ambient lighting, but they create problems of undesired product heating in the case of stoppage of the conveyer chain of the same.

The problem has been solved by providing intermitted lighting means, but the high power of the lighting means requires a strict control, which at each measurement should ensure the achievement of steady conditions and therefore the reliability and repeatability of the measurements made.

Moreover, the conveyer links are designed for an average product size, and are not much suitable for the control of products whose size considerably differs from the average; to this end, we may consider kiwis and melons. To obviate the above disadvantages, portable devices have also been devised, which substantially comprise a body that can be gripped like a gun, which exhibits an appendix at the end of which there is a crown of lighting means at the centre of which there is arranged an objective for gathering and concentrating the refracted light.

The use of such portable devices provides for the appendix end to rest on the product surface so that the refracted light is gathered by the objective.

Also the known portable devices, however, have proven partly unsatisfactory, since the intermittent actuation of the lighting means does not guarantee that they are always at steady state when the measurements are made; moreover, the poor lighting power makes the device very sensitive to the influence of the ambient lighting.

Last but not least, the concentration of lighting in limited product zones makes the device unsuitable for controlling fruits of a size larger than the average and with a hard skin.

The object of the present invention is to provide a unit for the spectroscopic control of vegetal products which should be of such a size as to be contained in a case while not exhibiting the disadvantages of the prior art.

### DISCLOSURE OF INVENTION

Said object is achieved by a device, and a relevant operating method, having the features described in the claims.

In particular, the method according to the finding comprises the following operating steps:

arranging at least two lamps, angularly spaced from one another, about means adapted for resting on the product to be analysed;
arranging a spectrometer below the product, powering said lamps at a reduced voltage as compared to the nominal power supply voltage so as to keep them pre-heated in a stand-by status,
changing the power supply voltage in an instant manner up to the nominal power supply voltage for causing the emission of a light flash for the time required to carry out the measurement.

The advantages and the functional and construction features of the finding will appear clearly from the following description which, with reference to the annexed drawing tables, illustrates a particular preferred embodiment thereof, made by way of a non-limiting example.

### BRIEF DESCRIPTION OF DRAWINGS

FIG. 1 shows a perspective view of the finding;

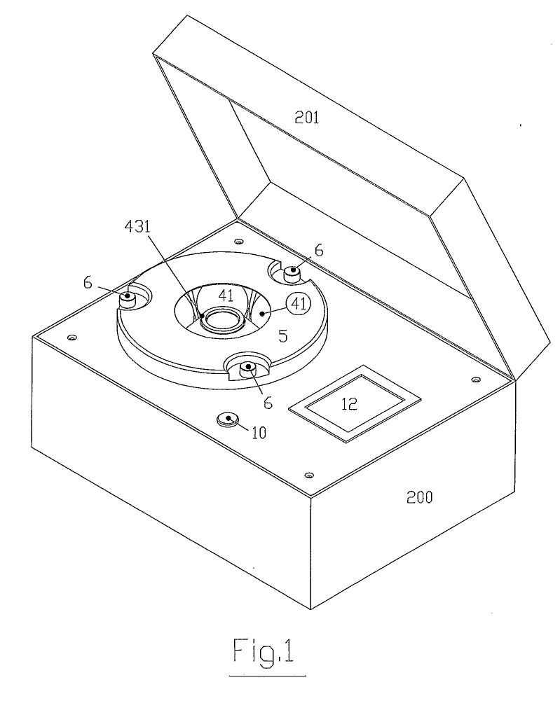

FIG. 2 shows a plan view of the finding;

FIG. 3 shows a plan view of the finding without a detail;

FIG. 4 shows section IV-IV marked in FIG. 2, with the electrical block diagram.

FIG. 5 shows section IV-IV marked in FIG. 2, wherein there is shown a variation of the electrical operating diagram.

FIG. 6 shows a second embodiment of the finding, in the same section as in FIG. 5.

### BEST MODE FOR CARRYING OUT THE INVENTION

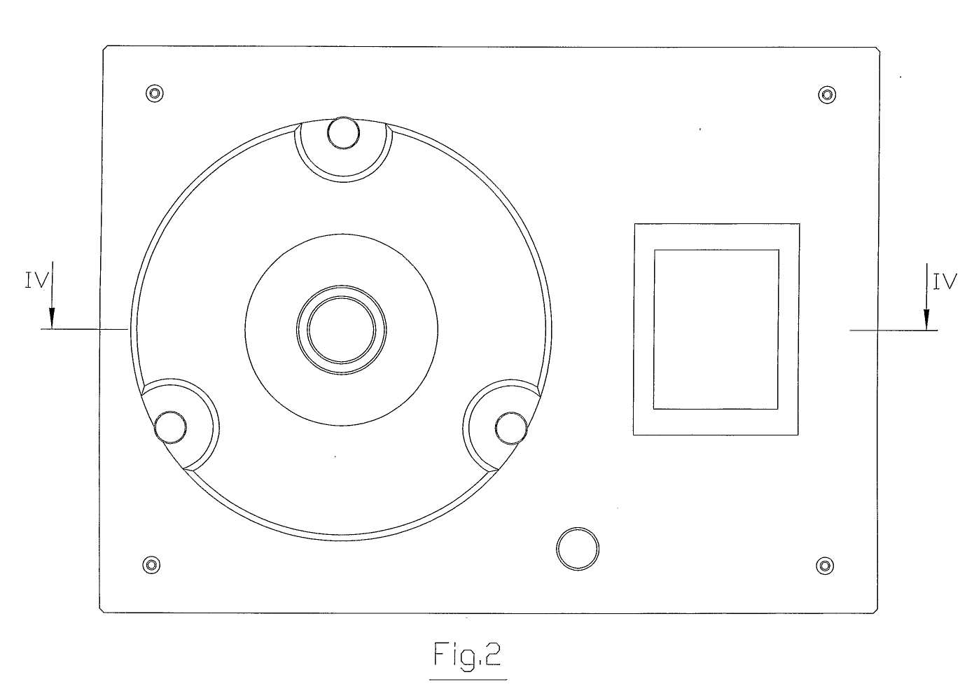

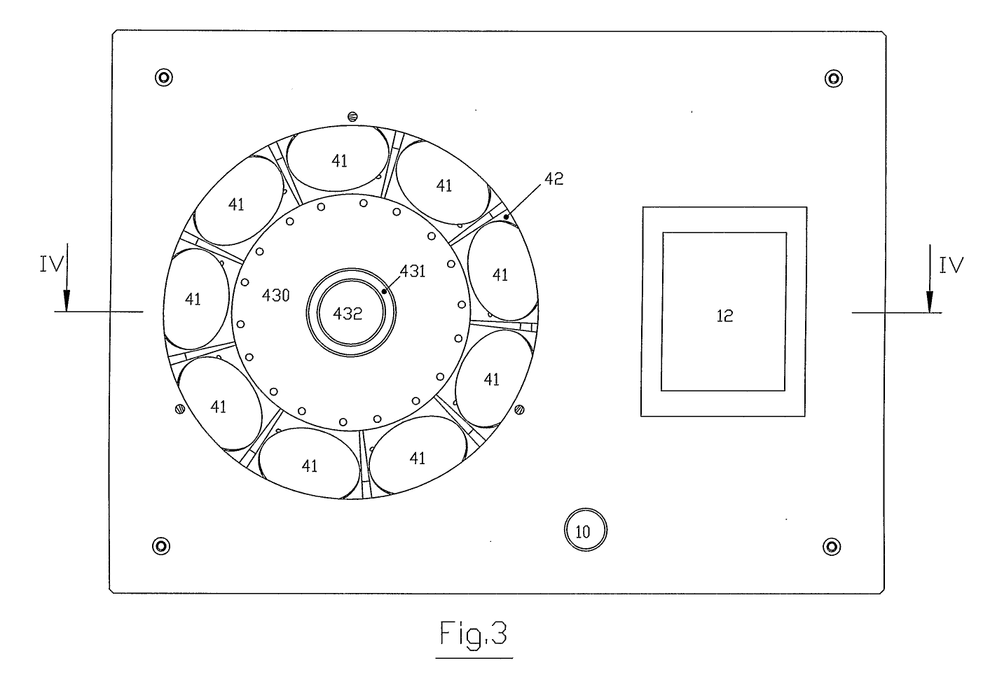

In the figures from FIG. 2 to FIG. 4, it can be seen that the finding comprises a bottom plate 1 and a top plate 2 connected by four posts 3 with adjustable length.

In particular, each post comprises a portion 31 fixed to plate 1 on which a portion 32 turnable and coupled to plate 2 is screwed.

On portion 32 there is arranged a toothed pulley 33, and pulleys 33 of each post are connected by a toothed belt 34, so as to rotate by identical amounts for allowing the adjustment of the distance between plates 1 and 2 keeping them strictly parallel to each other.

Plate 2 comprises a hole 21 of a diameter equal to that of an underlying crown 4 of lighting means.

In the example shown, crown 4 consists of nine lamps 41 supported by a truncated-cone sheet bell 42 so as to be converging upwards with an angle of about 45° relative to the vertical.

Bell 42 is supported by a hollow central body 43 whose top truncated-cone surface 430 is inclined by 450 relative to the vertical and is mirror polished, so as to be reflecting.

The hollow truncated-cone body 43 is supported by a bottom shelf 44 connected to the bottom plate 1, to which there is also fixed a spectrometer 45 of known construction whose lens for receiving the light beams to be analysed is arranged below a hole 440 of the shelf aligned with the cavity 432 of the hollow body.

Cavity 432 comprises an edge 431 at the top adapted for receiving the fruit to be analysed by rest. In the embodiment shown, said edge is of deformable type, but it may also be of the stiff type, according to the type of product to be analysed.

Into cavity 432 there is arranged a lens 433 adapted for concentrating the light beam that has crossed the fruit on the input lens of the underlying spectrometer 45.

Hole 21 is partly closed by a top body 5 having a hole 51 coaxial with hole 21.

Hole 51 has a diameter of intermediate value between that of hole 21 and that of cavity 432, and is arranged at the top of a specular or reflecting truncated-cone surface 52 inclined by an amount similar to the amount of the inclination of the truncated-cone surface 430 relative to the vertical.

It is noted that in other embodiments, the top body 5 is fixed to the top plate 2 by three equally-spaced screws 6 arranged on the same circumference.

Lamps 41, which in the example shown are of the halogen type with back aluminium parabola, normally available on the market, address a light beam shaped as circular crown against the product, not shown, resting on the deformable edge 431; the width of the lighted zone is adjusted by varying the height of plate 3 by the actuation of pulleys 33.

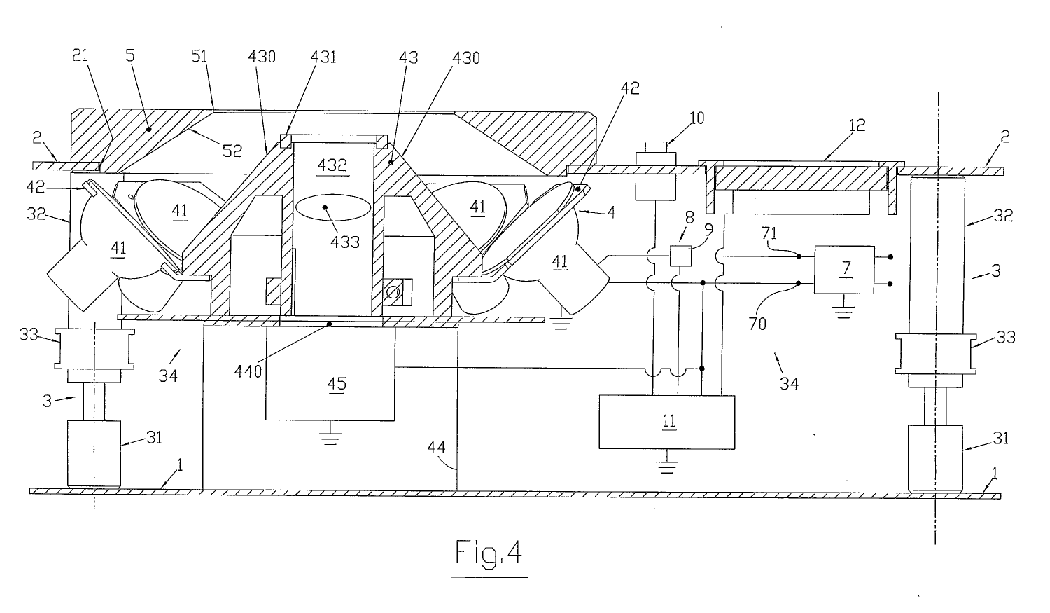

The maximum power absorbed by the nine lamps as a whole is in the range of 200 W, and they are powered by the circuit shown in blocks in FIG. 4.

The circuit comprises an electronic or stabilised power supply 7, having two output terminals, of which one 70 at reduced voltage and one 71 at nominal voltage. The stabiliser input is intended for being connected to an energy source, such as the 220 VAC mains.

In the embodiment shown, the voltage available at the output terminal 70 is equal to about one fifth the nominal voltage available at the output terminal 71, whose value is 24 Volts.

The output terminal 70 of the power supply 7 is intended for powering lamps 41, the spectrometer (45), a microprocessor 11, and display means at reduced voltage. Lamps 41 are also directly connected to output 71, at nominal voltage, of the power supply 7 through a power circuit 8, whose actuation is commanded and controlled by the microprocessor 11.

The power circuit (FIG. 4) comprises a controlled switch 9, which can be obtained with any type of switching device suitable for the purpose, for example with a power transistor type IGBT, or GTO, or MOS/FET or SCR.

An external button 10 sends an actuation signal to microprocessor 11 which controls the actuation of the power circuit, that is, with reference to the circuit of FIG. 4, the conduction of the switching device for a very short time interval, in the range of one second. In this way, lamps 41 are powered at the nominal voltage, which causes the emission of a pulse, or flash, of light sufficient for making the measurement.

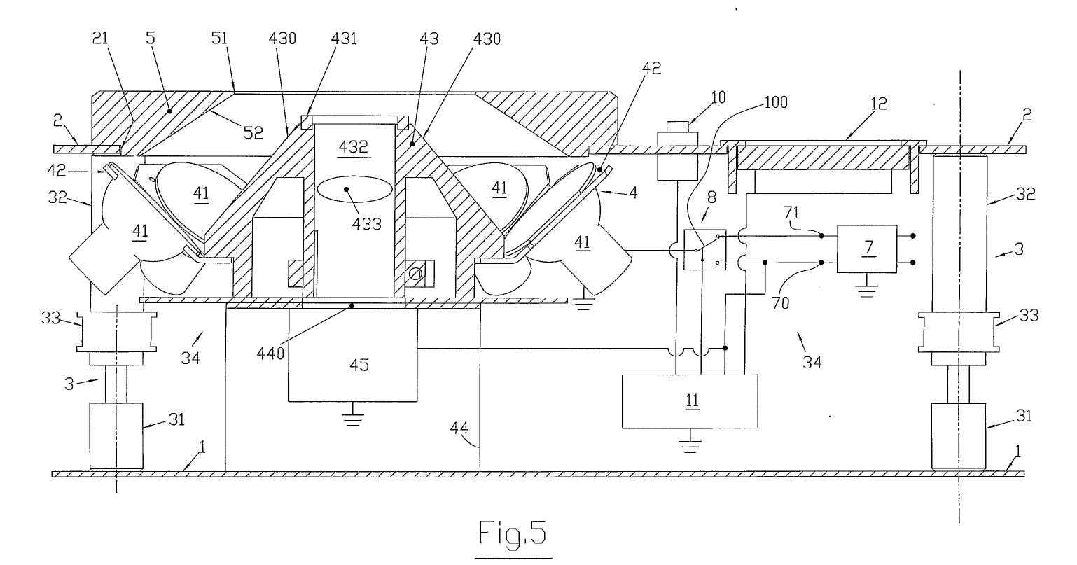

According to the variation of FIG. 5, the controlled switch comprises a usual commutator switch 100 adapted for alternately connecting the lamps to terminal 70 (reduced voltage output) or 71 (nominal voltage output). In the case of the circuit of FIG. 5, microprocessor 11, following the actuation signal generated by the pressure of button 10, controls the switching of the commutator switch 100 from terminal 70 to terminal 71, so as to power the lamps at the nominal voltage rather than the reduced voltage. After a very short time interval, sufficient for the emission of the light pulse by the lamps, microprocessor 11 controls the switching of the commutator switch 100 again from terminal 71 to terminal 70 so as to power the lamps at the reduced voltage again. From the description above it is clear that normally, lamps 41 are powered at a reduced voltage, which allows keeping them pre-heated in a stand-by status. When the measurement must be made, the operator presses button 10, thus generating an actuation signal received by microprocessor 11.

Following the actuation signal, microprocessor 11 controls the actuation of the power circuit which powers the lamps at the nominal voltage for a very short time interval, substantially instantaneous. The quick variation of the power supply voltage causes the emission of the pulse, or flash, of light required to make the measurement.

This has the advantage that the generation of the light pulse occurs very quickly so that the product is subject to the temperature emitted by the lamps, harmful for the storage thereof, only for the minimum time required to make the measurement.

Microprocessor 11 is also connected to the display means adapted for displaying the results of the measurement made, such as a screen 12.

Button 10 may be replaced by a device associated to the deformable edge 431, for the automatic transmission of the signal generated by the rest of the product to the microprocessor.

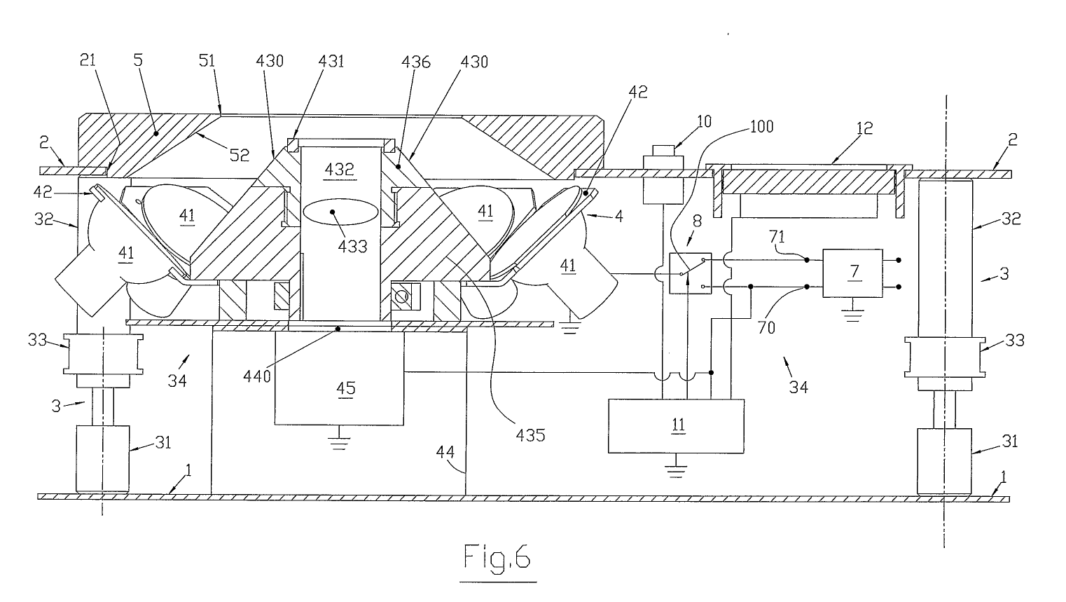

FIG. 6 shows a further embodiment relating to the support means of the fruit to be analysed.

In FIG. 6, the components in common with FIG. 5 are indicated with the same reference numerals.

The embodiment of FIG. 6 has the task of allowing the analysis of fruits having sizes very different from one another.

To this end, the hollow truncated-cone body 43 consists of a fixed bottom portion 435 fixed to the bottom shelf 44 connected to the bottom plate 1, and of a removable top portion 436 which carries the usual edge 431.

In the example shown, lens 433 is contained in the removable top portion, but the same may be more conveniently arranged in the fixed bottom portion.

The removable portion 436 is screwed on the fixed portion, and is available in different sizes, specifically different heights, based on the diameter of the fruit to be analysed.

The larger the fruit diameter, the higher the height of the removable portion.

For very small fruits, the use of a removable portion exhibiting the top seat defined by edge 431 of conveniently smaller diameter is provided.

The device now described is contained in a case 200 comprising a cover 201, whose size in the range of 300×400×200 mm make the whole easy to carry.

The device operation is as follows.

The device is connected to the mains, and lamps 41 are powered in stand-by condition at low voltage until they reach a temperature close to the steady temperature.

The height of the top plate 2 is adjusted based on the fruit diameter for concentrating the light beam on the fruit compatibly and suitably for the size of the fruit itself.

The fruit is rested on edge 431 which masks the ambient light, and then button 10 is actuated.

A light flash is thus emitted at the maximum power of the lamps, and for the instant required for making the measurement. The measurement results are displayed on the screen, and the operation can be repeated indefinitely without the need of waiting that lamps 41 reach the steady conditions again, which are maintained by the low voltage power supply.

It is noted that in place of microprocessor 11 it is also possible to use a microcontroller or, more in general, any programmable logic device. Moreover, the microprocessor may be provided with means adapted for interfacing it to data transmission networks or to other processors.

1. A portable device for the quality control of products comprising a power supply (7), a circular crown (4) of lighting lamps (41), powered by said power supply (7), at the centre of which there is arranged the receiving objective of a spectrometer (45) provided with means adapted for resting on the product to be checked, said spectrometer (45) being associated to a microprocessor (11) which provides the measurement data on display means, wherein the lamps (41) of said circular crown (4) are permanently powered, and in stand-by, at a reduced voltage, lower than the nominal voltage delivered by the power supply, and instantaneously at the nominal voltage supplied by the power supply (7) through a power circuit (8) whose actuation is commanded and controlled by the microprocessor (11) in response to an actuation signal, characterised in that said circular crown (4) of lamps 41 is oriented in order to face two truncated cone surfaces (430,52) made of reflective material and facing one another, to allow said circular crown (4) of lamps (41) to address a light beam shaped as a circular crown against the product.

2. A device according to claim 1, characterised in that said power circuit comprises a controlled switch (9).

3. A device according to claim 2, characterised in that said controlled switch is a commutator (100).

4. A device according to claim 2, characterised in that said controlled switch is a power transistor.

5. A device according to claim 1, characterised in that said circular crown (4) of lamps is supported by a diameter between that of the cavity of the hollow body (43) and that of the crown (4) of lighting lamps.

12. A device according to claim 11, characterised in that the surface of the top body (5) facing the hollow body (43) facing the truncated-cone surface of the same has a truncated cone shape.

13. A device according to claim 11, characterised in that the surface of the top body (5) facing the truncated-cone surface of the hollow body (43) is reflecting.

14. A device according to claim 11, characterised in that the distance between the hollow body (43) and the top body (5) is adjustable.

15. A device according to claim 14, characterised in that the hollow body (43) is integral to a bottom plate (1) and the top body (5) is integral to a top plate (2), said plates being connected by posts (3) of adjustable length.

16. A device according to claim 15, characterised in that said posts (3) comprise a first portion (31) fixed to the bottom plate (1) and a second portion (32), screwable on the first one, associated to the top plate (2), the second portions of the posts (3) being constrained to rotate by the same amount.

17. A device according to claim 1, characterised in that said display means comprises a screen (12).

18. A method for detecting the quality of products comprising the following operating steps:
arranging at least two lamps (41), angularly spaced from one another, about means adapted for resting on the product to be analysed;
arranging a crown of reflective material to guide the light of the lamps (41) according to a plurality of directions around said product;
arranging a spectrometer (45) below the product,
powering said lamps (41) at a reduced voltage as compared to the nominal power supply voltage so as to keep them pre-heated in a stand-by status,
changing the power supply voltage in an instant manner up to the nominal power supply voltage for causing the emission of a light flash for the time required to carry out the measurement.

19. A method according to claim 18, characterised in that the variation of the power supply voltage of said lamps occurs based on an actuation signal.

20. A method according to claim 18, characterised in that the power supply voltage of the lamps (41) is varied by the value reduced to the maximum nominal value for a time interval in the range of one second.
